(19) United States
(12) Patent Application Publication
(10) Pub. No.: US 2007/0217145 A1
(43) Pub. Date: Sep. 20, 2007

(54) Adaptor tray for use with rechargeable portable electronic products and universal docking stations

(76) Inventor: Elaine C.Y. Sung, Hong Kong (HK)

Correspondence Address: ERIC HANSCOM, 7395 PORTAGE WAY, CARLSBAD, CA, 92011, US

(21) Appl. No.: 11/378,410

(22) Filed: Mar. 20, 2006

(51) Int. Cl. G06F 1/16

(52) U.S. Cl. 361/686

(57) ABSTRACT

This invention is directed toward an adaptor tray designed to fit into the docking station of the docking unit for handheld electronic devices designed to accommodate more than one size, shape, or style of unit. The adaptor tray has a bottom and side configuration which mates with the sides and latches of the docking station sides, and has a central cavity only slightly larger than the docking base of the handheld electronic device. The cavity serves to guide the docking base onto the electrical connection in the base of the docking station, which minimizes wear and tear on both the docking port of the docking station and the docking adaptor on the handheld electronic device. The sides of the adaptor try serve to support the front, back and sides of the handheld device, keeping it from moving and thereby putting stress on the electrical connection.

### CROSS REFERENCE TO RELATED APPLICATIONS

None.

### STATEMENT REGARDING FEDERALLY SPONSORED RESEARCH OR DEVELOPMENT

This invention was not federally sponsored.

### BACKGROUND OF THE INVENTION

### Field of the Invention

This invention relates to the general field of electronics and docking units for handheld electronic products, and more specifically, to a an adaptor tray designed to fit into the docking station of the docking unit for handheld electronic devices designed to accommodate more than one size, shape, or style of unit. The adaptor tray has a bottom and side configuration which mates with the sides and latches of the docking station sides, and has a central cavity only slightly larger than the docking base of the handheld electronic device. The cavity serves to guide the docking base onto the electrical connection in the base of the docking station, which minimizes wear and tear on both the docking port of the docking station and the docking adaptor on the handheld electronic device. The sides of the adaptor try serve to support the front, back and sides of the handheld device, keeping it from moving and thereby putting stress on the electrical connection. A set. of these adaptor trays can be manufactured and sold with every docking station, where each adaptor tray is designed to fit a particular model of the handheld, such that an owner of a handheld of that particular brand need only buy one docking station and select the proper adaptor tray for his or her handheld or handhelds.

Handheld electronic devices have been popular for decades. While the early versions often ran off replaceable batteries, modern versions almost all have an internal, rechargeable battery. Most handheld electronic devices are recharged from a docking station, which is a generally squat unit with a cord which is plugged into a nearby electrical outlet. The cord is connected through the docking station to a docking port, which allows the electricity from the wall socket to recharge the handheld electronic device while it sits in the docking station, through an electrical connector at the (usually) bottom of the handheld. Docking stations often have additional purposes, such as allowing the handheld electronic device to interface with a computer or other electronic device such that information can be downloaded and shared between the handheld electronic device and other sources of information.

The most delicate part of this operation is the regular insertion of the handheld into the docking station, as the junction between the handheld's electrical connector and the docking port of the docking station is relatively fragile compared with other parts of both systems. Considering that many handheld electronic devices are recharged or inserting into the docking station of convey electronic data at least once a day, there exists a substantial danger that the repeated insertion, removal, and reinsertion of the handheld will damage the electrical connection with the docking station. If the damage is done to the docking station, it is of lesser consequence as the owner of the handheld needs to merely purchase another, which can usually be accomplished for less than $50. Damage to the handheld's electrical connector, on the other hand, can be catastrophic.

In addition to potentially losing a device which can run in the hundreds or thousands of dollars, and prevent the owner of the handheld from moving critical data from the handheld to another device before the power for the handheld runs out. In today's society, where the loss of crucial data even for a day can ruin a businessperson, or a business, there is a real need for an invention which minimizes the potential damage to the electrical connection between a handheld electronic device and the charging port of a docking station.

Adding to this danger is the fact that many of the docking stations on the market today attempt to be “unversal” for a particular brand of handheld electronic device. For example, Apple Computers makes the iPod line of portable, handheld electronic devices which store music. There are several different versions of the iPod, ranging in width and length quite considerably. Rather than trying to create a separate sized docking station for each iPod, most manufacturers create only one model of docking station, which has a cavity large enough to accommodate the largest iPod made. While such a docking station supports the largest iPod model quite well, the smaller, thinner models must rely on support only from the connection between the charging port of the docking station and their own electrical connection, which, as pointed out before, is the proverbial “weak link” in the process of keeping the handheld charged up and making sure that data transfer can occur every time it is placed on the docking station.

Thus there has existed a long-felt need for an invention that allows a manufacturer of docking stations to make only one model for an entire range of handheld electronic device sizes and shapes, and still allow a user of each model to use the docking station in a manner which will not overstress the electrical connections between the handheld and the docking station. The current invention provides just such a solution by having an adaptor tray designed to fit into the docking station of the docking unit for handheld electronic devices designed to accommodate more than one size, shape, or style of unit. The adaptor tray has a bottom and side configuration which mates with the sides and latches of the docking station sides, and has a central cavity only slightly larger than the docking base of the handheld electronic device. The cavity serves to guide the docking base onto the electrical connection in the base of the docking station, which minimizes wear and tear on both the docking port of the docking station and the docking adaptor on the handheld electronic device. The sides of the adaptor try serve to support the front, back and sides of the handheld device, keeping it from moving and thereby putting stress on the electrical connection. Because there can be a separate adaptor tray made for each model of handheld in a particular line of products, a set of adaptor trays can be sold with each docking station, thereby allowing a user of the handheld to select the particular shape and size of an adaptor tray to allow his or her particular handheld electronic device to nestle into the docking station and be supported on its front, back and sides by the confines of the adaptor tray.

### SUMMARY OF THE INVENTION

It is a principal object of the invention to provide an adaptor tray that allows a handheld electronic device to be inserted into a docking station for charging, data transfer, or other reasons with a minimum of stress on the electrical connection between the handheld and the docking station.

It is another object of the invention to provide support on the front, back, and sides of the handheld electronic device as it nestles in the docking station.

It is an additional object of the invention that a complete line of these tray adaptors can be manufactured such that a docking station intended for use with more than one models in a line of products can function effectively with the all models in a line of products through the user's selection of the appropriate adaptor tray.

It is a further object of the invention that the adaptor tray is easy to insert and remove.

It is also an object of this invention that the adaptor tray serves as a guide which allows an owner of a handheld electronic device to insert it into the docking station more quickly and with less precision that he/she would normally take as the sides of the adaptor tray mate with the sides of the handheld electronic device sufficiently to naturally guide the electronic connection of the handheld electronic device directly into the charging port of the docking station.

It is a final object of this invention that the adaptor trays can be manufactured inexpensively such that a maker of docking stations finds it economically feasible to include a set of adaptor trays with each docking station designed for a particular brand or model line of handheld electronic devices.

It should be understood the while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

FIG. 1 is a front, perspective view of a handheld electronic device (here, an ipod) in a docking station with the proper sized adaptor tray already inserted into the docking station.

FIG. 2 is a back, perspective view of a handheld electronic device (here, an ipod) in a docking station with the proper sized adaptor tray already inserted into the docking station.

FIG. 3 is a top view of a docking station with an adaptor tray already inserted.

FIG. 4 is a top, perspective view of a docking station with an adaptor tray already inserted.

FIG. 5 is a side, partial cut-away view of an adaptor tray.

FIG. 6 is a top view of an adaptor tray.

FIG. 7 is a top, perspective view of an adaptor tray.

FIG. 8 is a back, perspective view of another model of handheld electronic device inserted into a docking with a different adaptor tray than the one used in FIG. 2.

FIG. 9 is a drawing of the variety of adaptor trays made for docking stations made to work with the iPod handheld electronic device.

### DETAILED DESCRIPTION OF THE FIGURES

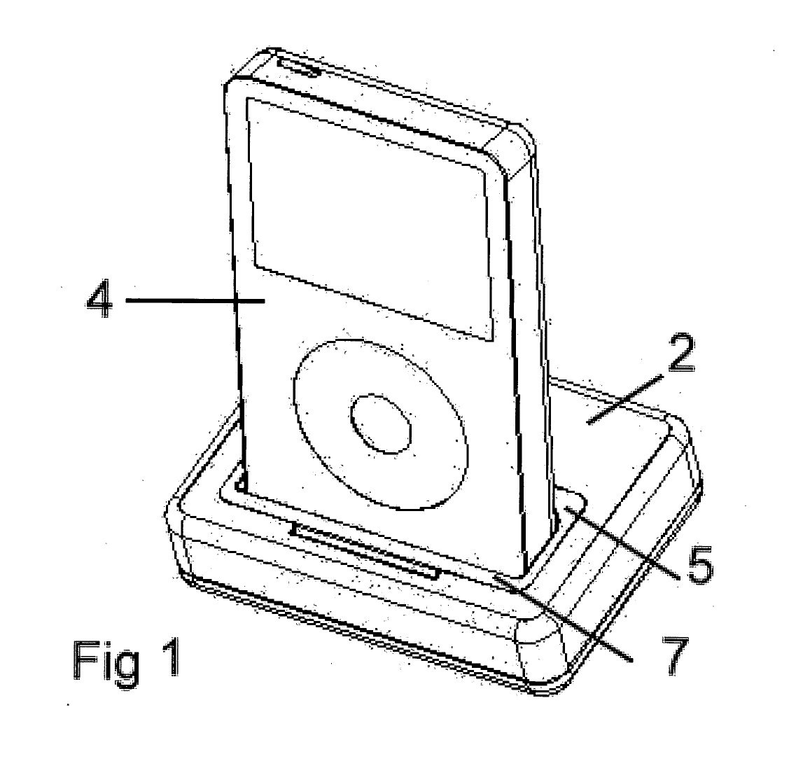

FIG. 1 is a front, perspective view of a handheld electronic device (4) (here, an iPod) in a docking station (2) with the proper sized adaptor tray already inserted into the docking station. The adaptor tray, when seen from this angle, has only a skirt visible. In this figure, the handheld electronic device is a fairly large one for this particular line of products, so the front skirt (7) is thinner than the back skirt (5). The purpose of the skirt is to create an opening into the charging cavity of the docking station that is precisely the same shape and the shape of the bottom of that portion of the handheld electronic device that is to be inserted into the charging cavity of the docking station.

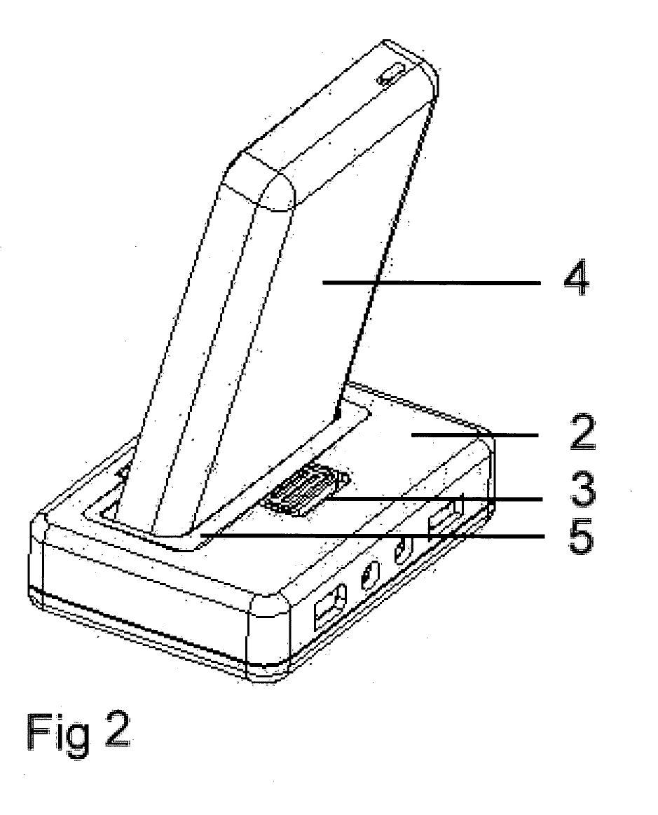

FIG. 2 is a back, perspective view of a handheld electronic device (4) (here, an ipod) in a docking station (2) with the proper sized adaptor tray already inserted into the docking station. This figure also shows how the docking station has a release tab (3) which removably connects to the back skirt (5) of the adaptor tray.

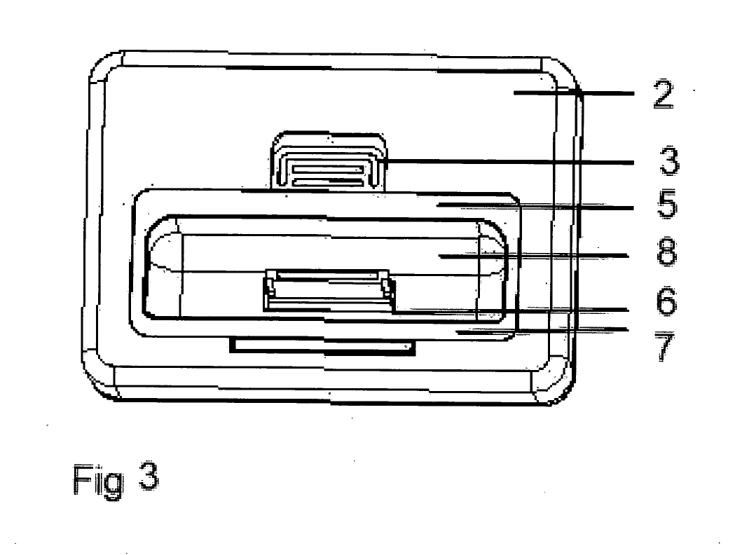

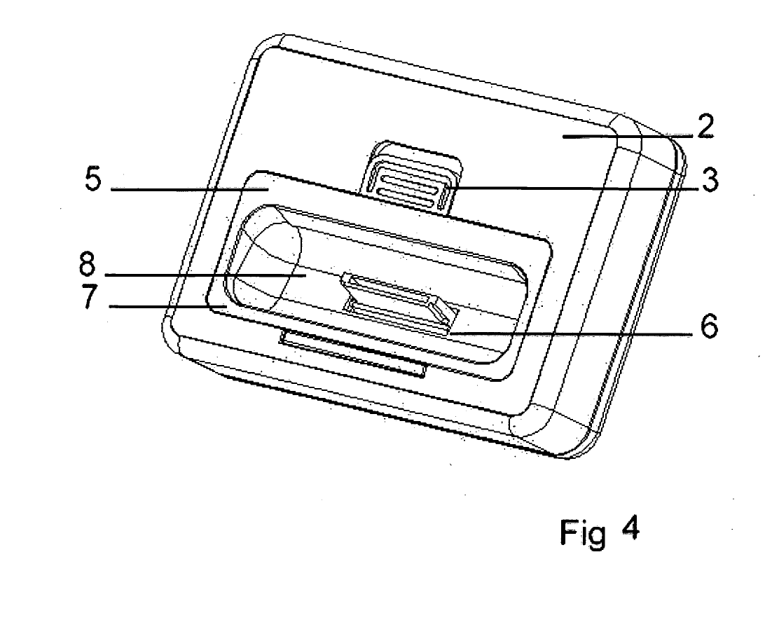

FIG. 3 is a top view and FIG. 4 is a top, perspective view of a docking station (2) with an adaptor tray already inserted. The release tab (3) on the docking station can be pulled back to remove the adaptor tray currently in the charging cavity in case the user of the invention wishes to charge or transfer data from a different handheld electronic device.

The adaptor try has a skirt which runs all around the edge of the charging cavity, with a back skirt (5) and a front skirt (7), where the relative widths of the skirts can be modified for each different model of handheld electronic device for which the docking station is intended to function. The adaptor tray also has sides which creates a cavity (8) which conforms to the shape of the end of the handheld electronic device for which it is designed, and a slot on the bottom of a proper size to fit over the charging port of the docking station. Thus, with the skirt and side portions of the adaptor tray designed to allow a handheld electronic device to nestle very snugly inside of its confines, a user can insert a handheld electronic device and push down without taking the time to align the electrical connection of the handheld electronic device with the charging port of the docking station. The sides and skirt of the adaptor tray also serve to keep the handheld electronic device from rocking back and forth or twisting during insertion or removal, and avoids the current situation in universal docking stations where a smaller handheld electronic device maintains its charging/data transfer angle in the docking station only through its point of attachment to the charging port of the docking station, thereby minimizing the potential damage to this critical electrical connection between the docking station and the handheld electronic device.

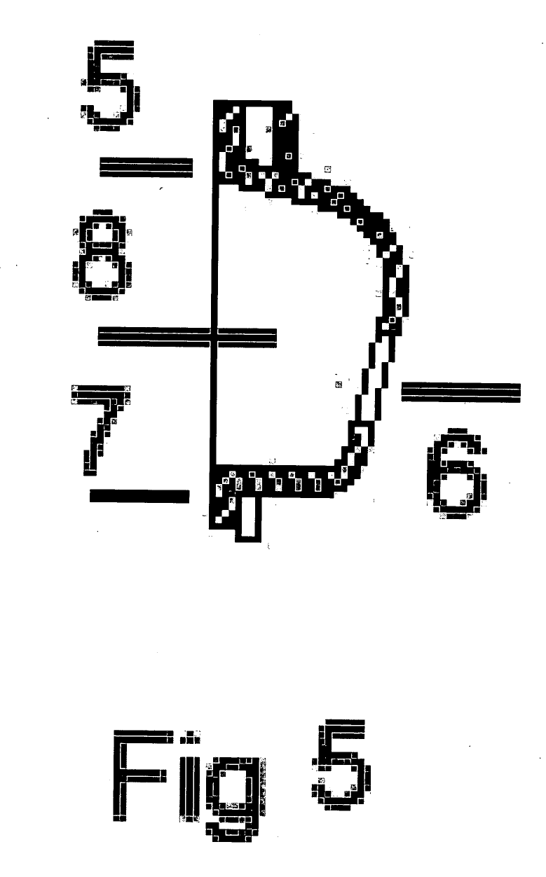

FIG. 5 is a side, partial cut-away view of an adaptor tray. The back skirt (5) and front skirt (7) are designed to lie flat on the surface of the docking station, and they terminate in the sides (9) which are designed to cup and support the sides of the handheld electronic device as they create a cavity (8) which is nearly the exact shape of that portion of the handheld electronic device intended for insertion into the docking station. This Figure also illustrates the means by which the adaptor tray is removably attached to the docking station. The adaptor tray has a release tab clip (11) just under the outer lip of the back skirt (5), which is removably engaged by the release tab (not shown in this figure) of the docking station. The adaptor tray also has two or more front clips (12) which fit into cavities in the docking station, thereby preventing the front skirt (7) of the adaptor tray from being pried up and out of the charging cavity of the docking station by the force of the handheld electronic device.

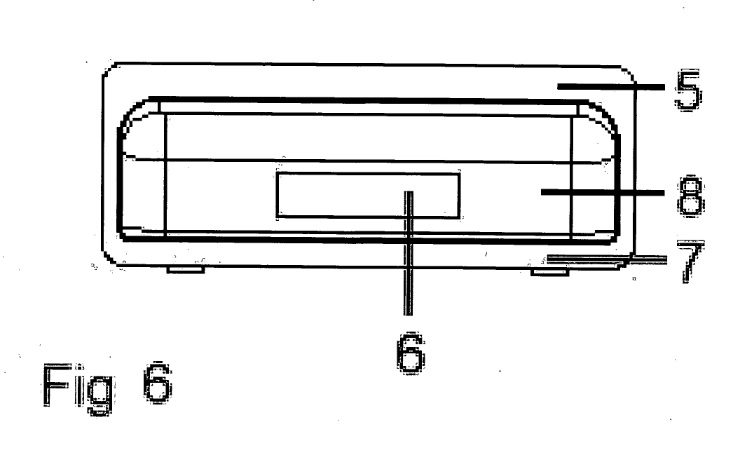

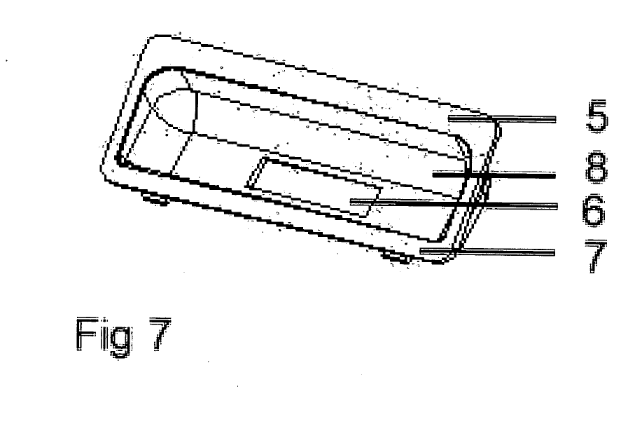

FIG. 6 is a top view and FIG. 7 is a top, perspective view of an adaptor tray showing the key components visible from this angle, including the back skirt (5), the front skirt (7), the slot (6), and the cavity (8).

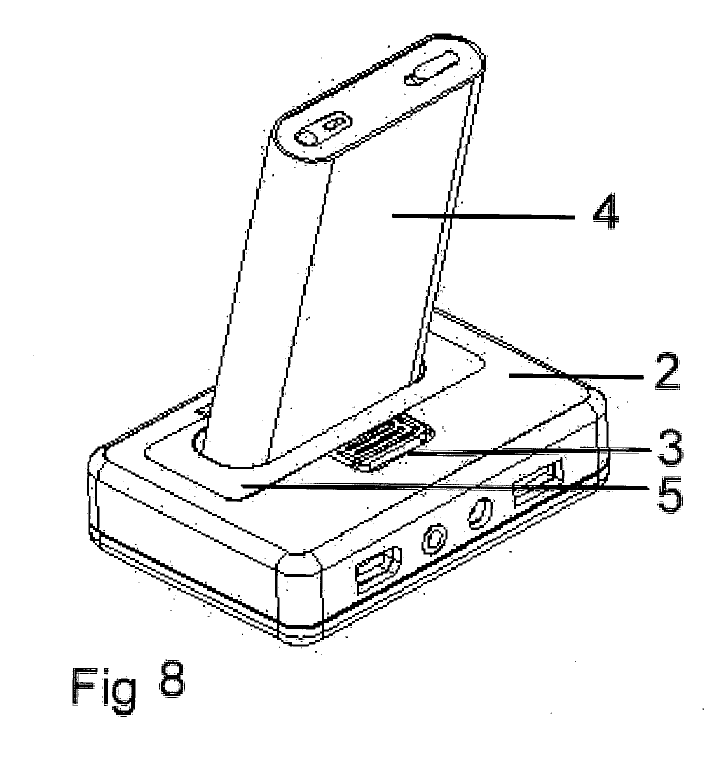

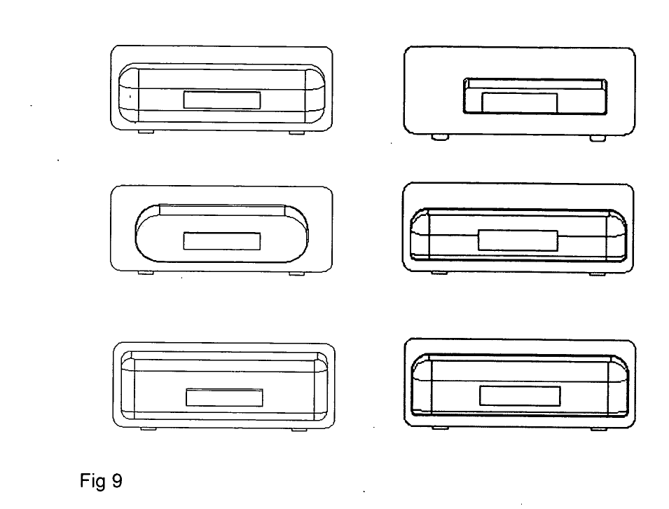

FIG. 8 is a back, perspective view of another model of handheld electronic device (4) inserted into a docking with a different adaptor tray than the one used in FIG. 2. Here, the handheld electronic device is much smaller and thinner than that shown in FIG. 2, so a different adaptor tray is used, one with a wider skirt on all sides, including a semi-circular side skirt (10) to conform to the shape of the handheld electronic device.

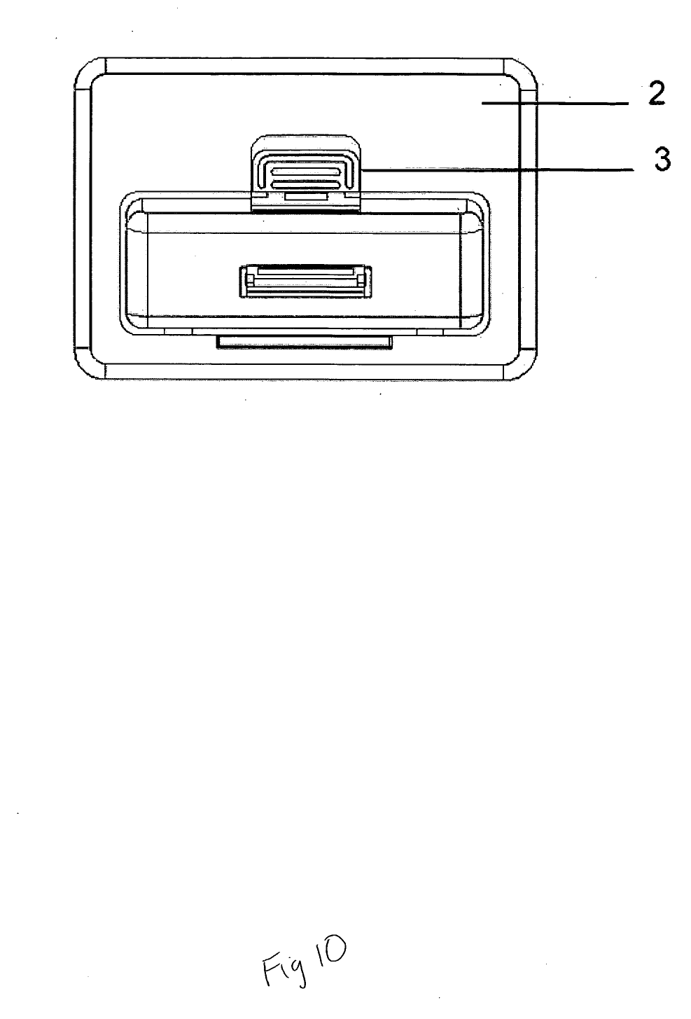

FIG. 9 is a drawing of the variety of adaptor trays made for docking stations made to work with the iPod handheld electronic device. While all the adaptor trays illustrated in this Figure have the key components of the other adaptor trays, there are noticeable differences in the shapes and widths of the skirts, which will, of course, translate into different cavities defined by the sides of the adaptor tray extending down from the edges of the skirts.

What I claim is:

1. A device for allowing a docking station to accommodate more than one model of a handheld electronic device, comprising a plurality of individual adaptor trays, each comprising:
four sides and a bottom which define a cavity;
means for retaining the device inside the charging cavity of a docking station; and,
means for connecting the electrical connector of the handheld electronic device to the charging port of the docking station;
where, the cavity is of such a size that it allows that portion of the handheld electronic device intended for insertion into the charging cavity of the docking station to fit snugly within the four sides and the bottom of the device;
where, each of the plurality of individual adaptor trays is designed to accommodate a different model of a particular line of handheld electronic devices.

2. The device of claim 1, where each of the individual adaptor trays additionally comprises a front skirt, a back skirt, and two side skirts, where the front skirt, back skirt, and two side skirts form one continuous skirt around the edge of the adaptor, and where the four sides begin at the edges of the front skirt, a back skirt, and two side skirts and terminate at the bottom.

3. The device of claim 2, where the front skirt, back skirt, and two side skirts lie in a flat plane with the surface of the docking station when the device is inserted into the charging cavity of the docking station.

4. The device of claim 1, where the means of retaining the device within the charging cavity of the docking are a release tab clip and two or more front clips, where, the release tab clip can be removably engaged by a release tab located on the docking station, and the two or more front clips are located and designed such that each front clip fits into a cavity in the docking station which is sized appropriately to accommodate the front clip and prevent the device from releasing from the charging cavity when both the two or more front clips are inserted into the two or more cavities in the docking station and the release tab clip is engaged by the release tab of the docking station.

5. The device of claim 1, where the means for connecting the electrical connector of the handheld electronic device to the charging port of the docking station is a slot in the bottom of the device which is aligned with the charging port of the docking station such that the slot in the device fits over the charging port when the device is inserted into the charging cavity of the docking station, whereby the electrical connector of the handheld electronic device can removably engage the charging port through the slot in the device.

6. The device of claim 5, where the shape of the cavity created by the four sides and the bottom of the device is such that when a user of the invention inserts the handheld electronic device into the cavity, the electrical connector of the handheld electronic device is lined up with the charging port of the docking station such that the electrical connector of the handheld electronic device is connected to the charging port of the docking station without requiring the user of the invention to align the electrical connector of the handheld electronic device with the charging port of the docking station.

7. The device of claim 1 where the handheld electronic device is a model of iPod and the device is designed to accommodate that particular model of iPod.

8. The device of claim 7, where the device includes at least two individual adaptor trays designed to accommodate different models of iPod's.

9. The device of claim 7, where the device includes at least five individual adaptor trays designed to accommodate different models of iPod's.

10. The device of claim 1, where the individual adaptor trays are designed to accommodate a series of models from electronic handheld devices selected from the group comprising: iPods, GameBoys, PSP's, cell phones, Palm Pilots, and personal digital assistants.

11. A method of adapting a single docking station to a variety of handheld electronic unit models, comprising the steps of:
a) obtaining a plurality of adaptor trays designed for the line of handheld electronic devices which the user of the invention desires to recharge and transfer data between the handheld electronic device and another source of data such a as computer, each adaptor tray comprising:
four sides and a bottom which define a cavity;
means for retaining the device inside the charging cavity of a docking station; and,
means for connecting the electrical connector of the handheld electronic device to the charging port of the docking station;
where, the cavity is of such a size that it allows that portion of the handheld electronic device intended for insertion into the charging cavity of the docking station to fit snugly within the four sides and the bottom of the device;
where, each of the plurality of individual adaptor trays is designed to accommodate a different model of a particular line of handheld electronic devices,
b) selecting the proper size of adaptor tray for the particular model of handheld electronic device the user of the invention wishes to place in the docking station,
c) performing any charging operations desired,
d) performing any data transfer operations desired, and,
e) removing the handheld electronic device from the docking station.

12. The method of claim 11, where each of the individual adaptor trays additionally comprises a front skirt, a back skirt, and two side skirts, where the front skirt, back skirt, and two side skirts form one continuous skirt around the edge of the adaptor, and where the four sides begin at the edges of the front skirt, a back skirt, and two side skirts and terminate at the bottom.

13. The method of claim 12, where the front skirt, back skirt, and two side skirts lie in a flat plane with the surface of the docking station when the device is inserted into the charging cavity of the docking station.

14. The method of claim 12, where the means of retaining the device within the charging cavity of the docking are a release tab clip and two or more front clips, where, the release tab clip can be removably engaged by a release tab located on the docking station, and the two or more front clips are located and designed such that each front clip fits into a cavity in the docking station which is sized appropriately to accommodate the front clip and prevent the device from releasing from the charging cavity when both the two or more front clips are inserted into the two or more cavities in the docking station and the release tab clip is engaged by the release tab of the docking station.

15. The method of claim 11, where the means for connecting the electrical connector of the handheld electronic device to the charging port of the docking station is a slot in the bottom of the device which is aligned with the charging port of the docking station such that the slot in the device fits over the charging port when the device is inserted into the charging cavity of the docking station, whereby the electrical connector of the handheld electronic device can removably engage the charging port through the slot in the device.

16. The method of claim 15, where the shape of the cavity created by the four sides and the bottom of the device is such that when a user of the invention inserts the handheld electronic device into the cavity, the electrical connector of the handheld electronic device is lined up with the charging port of the docking station such that the electrical connector of the handheld electronic device is connected to the charging port of the docking station without requiring the user of the invention to align the electrical connector of the handheld electronic device with the charging port of the docking station.

17. The method of claim 11, where the handheld electronic device is a model of iPod and the device is designed to accommodate that particular model of iPod.

18. The method of claim 17, where the device includes at least two individual adaptor trays designed to accommodate different models of iPod's.

19. The method of claim 17, where the device includes at least five individual adaptor trays designed to accommodate different models of iPod's.

20. A device for allowing a docking station to accommodate more than one model of a handheld electronic device, comprising a plurality of individual adaptor trays, each comprising:
four sides and a bottom which define a cavity;
means for retaining the device inside the charging cavity of a docking station; and,
means for connecting the electrical connector of the handheld electronic device to the charging port of the docking station;
where, the cavity is of such a size that it allows that portion of the handheld electronic device intended for insertion into the charging cavity of the docking station to fit snugly within the four sides and the bottom of the device;
where, each of the plurality of individual adaptor trays is designed to accommodate a different model of a particular line of handheld electronic devices:
where, each of the individual adaptor trays additionally comprises a front skirt, a back skirt, and two side skirts, where the front skirt, back skirt, and two side skirts form one continuous skirt around the edge of the adaptor, and where the four sides begin at the edges of the front skirt, a back skirt, and two side skirts and terminate at the bottom;
where the front skirt, back skirt, and two side skirts lie in a flat plane with the surface of the docking station when the device is inserted into the charging cavity of the docking station;
where the means of retaining the device within the charging cavity of the docking are a release tab clip and two or more front clips, where, the release tab clip can be removably engaged by a release tab located on the docking station, and the two or more front clips are located and designed such that each front clip fits into a cavity in the docking station which is sized appropriately to accommodate the front clip and prevent the device from releasing from the charging cavity when both the two or more front clips are inserted into the two or more cavities in the docking station and the release tab clip is engaged by the release tab of the docking station;
where the means for connecting the electrical connector of the handheld electronic device to the charging port of the docking station is a slot in the bottom of the device which is aligned with the charging port of the docking station such that the slot in the device fits over the charging port when the device is inserted into the charging cavity of the docking station, whereby the electrical connector of the handheld electronic device can removably engage the charging port through the slot in the device; and,
where the shape of the cavity created by the four sides and the bottom of the device is such that when a user of the invention inserts the handheld electronic device into the cavity, the electrical connector of the handheld electronic device is lined up with the charging port of the docking station such that the electrical connector of the handheld electronic device is connected to the charging port of the docking station without requiring the user of the invention to align the electrical connector of the handheld electronic device with the charging port of the docking station.
